(19) United States
(12) Patent Application Publication
(10) Pub. No.: US 2026/0211135 A1
(43) Pub. Date: Jul. 23, 2026

(54) MARINE VIBRATOR WITH ONE OR MORE REMOTELY LOCATED COMPONENTS

(71) Applicant: Applied Physical Sciences Corp., Groton, CT (US)

(72) Inventors: Daniel Roy, Westerley, RI (US); Jonathan J. Fasano, Providence, RI (US)

(21) Appl. No.: 19/134,629

(22) PCT Filed: Dec. 1, 2023
(86) PCT No.: PCT/US23/82042

§ 371 Date: May 30, 2025

Related U.S. Application Data
(60) Provisional application No. 63/429,657, filed on Dec. 2, 2022.

(51) Int. Cl. G01V 1/145; G01V 1/38

(52) U.S. Cl. CPC G01V 1/145; G01V 1/38

(57) ABSTRACT

Marine vibrators and marine vibrator systems are provided herein having one or more remotely located components. An exemplary marine vibrator includes at least one electromagnetic transducer, a control-monitoring electronics system, and a frame, where the at least one electromagnetic transducer is at least partially within the frame. The at least one electromagnetic transducer receives alternating current (AC) electrical power from one or more power amplifiers, via at least one umbilical that connects the at least one electromagnetic transducer and the one or more power amplifiers, where the one or more power amplifiers are remotely located from the marine vibrator.

### CROSS-REFERENCE TO RELATED APPLICATION(S)

The present application claims priority to U.S. Provisional Patent Application Ser. No. 63/429,657, filed Dec. 2, 2022, entitled “Remotely Amplified Marine Vibrator,” which is incorporated by reference herein in its entirety.

### FIELD

The field relates generally to underwater sound projectors for use in connection with marine seismic surveys.

### BACKGROUND

Sound waves are the primary tool used to search for oil and gas reserves beneath the Earth's strata. Sound waves are convenient, for example, because they can propagate over long distances and penetrate into complex layered media to obtain important information regarding the presence, composition, and/or physical extent of such reserves (for surveys conducted on both land and water). Some techniques that have been used to generate sound waves in water rely on the use of air guns or marine vibrators.

### SUMMARY

Illustrative embodiments of the present disclosure provide marine vibrators and systems with one or more remotely located components.

In one exemplary embodiment, a marine vibrator includes at least one electromagnetic transducer, a control-monitoring electronics system, and a frame, where the at least one electromagnetic transducer is at least partially within the frame. The at least one electromagnetic transducer receives alternating current (AC) electrical power from one or more power amplifiers, via at least one umbilical that connects the at least one electromagnetic transducer and the one or more power amplifiers, where the one or more power amplifiers are remotely located from the marine vibrator.

In another exemplary embodiment, a marine vibrator system includes one or more power amplifiers, a control-monitoring electronics system, and at least one marine vibrator. The at least one marine vibrator includes at least one electromagnetic transducer and a frame, where the at least one electromagnetic transducer is at least partially within the frame. At least one of the one or more power amplifiers and at least a portion of the control-monitoring electronics system are remotely located from the at least one marine vibrator. The one or more power amplifiers transmit alternating current (AC) electrical power to the at least one electromagnetic transducer, via at least one umbilical that connects the at least one electromagnetic transducer to at least one of the one or more power amplifiers.

In yet another illustrative embodiment, a marine vibrator includes at least one electromagnetic transducer, where the at least one electromagnetic transducer comprises at least one piston; at least one moving armature assembly that drives the at least one piston based on alternating current (AC) electrical power received from one or more power amplifiers associated with the marine vibrator; a first set of sensors that measures an acceleration of the at least one piston, and a second set of sensors that measures an acceleration of a stator of the at least one moving armature assembly. The acceleration of the at least one piston relative to the acceleration of the stator is controlled, in substantially real time, by adjusting the AC electrical power based at least in part on the accelerations measured by the first set of sensors and the second set of sensors.

In another illustrative embodiment, a marine vibrator includes at least one electromagnetic transducer, where the at least one electromagnetic transducer receives AC electrical power from one or more power amplifiers that are remotely located from the at least one marine vibrator, via at least one umbilical that connects the at least one electromagnetic transducer and at least one of the one or more power amplifiers.

Illustrative embodiments described herein provide significant improvements relative to conventional marine vibrators by separating the power amplifier from the marine vibrator. For example, such embodiments reduce costs, improve access for maintenance and troubleshooting, and/or reduce the weight and size of the deployed marine vibrator. These and other features and advantages of the present disclosure will become more readily apparent from the accompanying drawings and the following detailed description.

### BRIEF DESCRIPTION OF THE DRAWINGS

FIG. 1 is an elevation drawing showing a first deployment arrangement comprising a remotely amplified marine vibrator in an illustrative embodiment.

FIG. 2 is an elevation drawing showing a second deployment arrangement comprising a remotely amplified marine vibrator in an illustrative embodiment.

FIG. 3 is an elevation drawing showing a third deployment arrangement of a marine vibrator having a remote amplifier and a remote control-monitoring electronics system in an illustrative embodiment.

FIG. 4 is an elevation drawing showing a fourth deployment arrangement comprising an array of marine vibrators in an illustrative embodiment.

FIG. 5 is an elevation drawing showing a fifth deployment arrangement comprising a remotely amplified marine vibrator suspended from a float in an illustrative embodiment.

FIG. 6 is an elevation drawing showing a sixth deployment arrangement comprising multiple remotely amplified marine vibrators suspended from a float in an illustrative embodiment.

FIG. 7A and FIG. 7B show front and side views, respectively, of a marine vibrator having two sets of sensors in accordance with illustrative embodiments.

### DETAILED DESCRIPTION

Air guns expel short bursts of high-pressure air and constitute an impulsive (i.e., incoherent) source of acoustic energy. The waves penetrate into the strata and differentially reflect back towards the surface where they are recorded by an array of receivers (i.e., hydrophones). Generally, marine seismic surveys are performed by towing a number of air guns (typically 12 to 48) in the form of multiple sub-arrays 300 to 500 meters behind a survey vessel at depths on the order of 1 to 10 meters. A series of surface floats are used to suspend the air guns (e.g., one float per sub-array) at the prescribed depth. An umbilical containing strength members, electrical power cables, a duplex data transfer medium (e.g., copper or fiber optic link), and a high-pressure air hose is used to tow the surface float from a survey vessel. A secondary purpose of the umbilical is to route high-pressure air to the air gun array, as well as electrical power to control various aspects of the array, and provide means to command the array and obtain monitoring data from various engineering sensors to ensure satisfactory operation is evident. Typical tow speeds range from 1.5 to 2.5 m/s which facilitates survey rates on the order of 10 km²/day. Additional information on marine seismic surveys can be found, for example, in “Marine Geophysical Operations: An Overview,” International Association of Geophysical Contractors (June 2009), or “An Overview of Marine Seismic Operations,” International Association of Oil and Gas Producers, Report No. 448 (April 2011).

Marine vibrators are an alternative to air guns that can provide a coherent source of acoustic energy (e.g., a non-impulsive, phase-controlled source of acoustic energy). Typically, applications and/or motivations to use marine vibrators in lieu of air guns stem from needing a better seismic signature in certain deep-water operational environments, performing marine seismic surveys in environmentally sensitive areas, and having an improved source for shallow water (e.g., transition zone) applications where air gun arrays have been found to perform sub-optimally. Other attributes of some marine vibrator-based seismic surveys that are desirable include: having command-actuated depth control to mitigate issues related to signal-to-noise ratio at low frequencies and ghosting, and having little to no surface expression (i.e., no floats) given that 40% of the Earth's oil and gas reserves are located in the Arctic where floating ice is a hazard.

At least some conventional marine vibrators include a frame (e.g., a free-flooding frame) comprising an electromagnetic transducer, at least one power amplifier, a control and monitoring system, and a pressure compensation system. In some implementations, the electromagnetic transducer can require up to 220 kilovolt-amperes (KVA) per channel, or up to 440 KVA per transducer. At the time of design and fabrication, power amplifiers (specifically, the internal semiconductor switches) were limited to approximately 1400 Volts peak output. The resulting current consumption of the electromagnetic transducer, when operating at 1400 volts peak, is approximately 220 Amps RMS per channel, or 440 Amps RMS per transducer. To satisfy this relatively high current, the power amplifier of the marine vibrator is often collocated with the transducer. This arrangement prevents excessively high voltage drops in the cable interconnecting the amplifier to the electromagnetic transducer or prevents use of excessively large conductors to mitigate the voltage drop in the interconnect cable. As an example, the power amplifier can be positioned within the frame and adjacent to the transducer. The power amplifier can be energized using direct current (DC) power supplied via an umbilical from one or more power supplies residing on a survey vessel. Further information related to marine vibrators may be found, for example, in U.S. Pat. No. 9,625,598, granted Apr. 18, 2017; U.S. Pat. No. 9,562,982 B1, granted Feb. 17, 2017; and U.S. Pat. No. 11,402,531 B2, granted Aug. 7, 2022, each incorporated by reference herein in their entirety.

One or more aspects of the disclosure recognize that marine vibrators where the power amplifier is collocated with the transducer can be expensive, difficult to deploy, and/or difficult to transport. For example, the power amplifier system in such collocated implementations needs to be ruggedized and marinized to withstand being submerged in water, and a large and heavy frame is required to retain the power amplifier and other components of the marine vibrator. Also, the power amplifier uses passive convection cooling that requires the marine vibrator to be placed in the water to operate, thereby making it inaccessible while a survey is being conducted.

Embodiments described herein address one or more of these issues by providing vibrator arrangements having a remote power amplifier. For example, in some embodiments, the power amplifier can be located at least partially above the water surface, while the marine vibrator is operating under water, as explained in more detail herein.

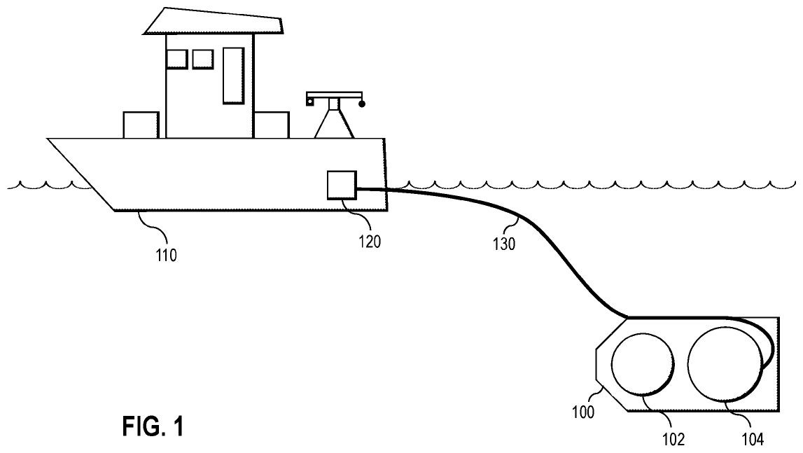

FIG. 1 is an elevation drawing showing a first deployment arrangement comprising a remotely amplified marine vibrator in an illustrative embodiment. More specifically, the example of FIG. 1 includes a marine vibrator 100 comprising a control-monitoring electronics system 102 and an electromagnetic transducer 104. In this example, it is assumed that the marine vibrator 100 is towed by a survey vessel 110 via an umbilical 130 that is connected to the electromagnetic transducer 104.

In some examples, the marine vibrator 100 can include a free-flooding frame. For example, the frame can be a skeleton-like frame (e.g., comprised of steel, aluminum, and/or other similar materials), where the control-monitoring electronics system 102 and/or the electromagnetic transducer 104 are located at least partially within the frame for protection during deployment and/or retrieval. Optionally, the frame can include one or more tow points used for connecting the frame to a survey vessel and/or float, as described in more detail elsewhere herein. In at least one embodiment, the control-monitoring electronics system 102 and/or the electromagnetic transducer 104 can be physically connected to the frame (e.g., directly connected to the frame, and/or using cables, springs, and/or the like). In other embodiments, the control-monitoring electronics system 102 and/or the electromagnetic transducer 104 can be surrounded (or at least partially surrounded) by the frame without being physically connected.

The umbilical 130, in some embodiments, is a flexible, load-bearing structure that is connected to the survey vessel 110 (which can be up to 1 km away, for example). The umbilical 130, in this embodiment, includes functionality to provide an AC drive signal from a power amplifier 120, located on the survey vessel 110, that is used to drive the electromagnetic transducer 104. In some embodiments, the umbilical 130 can also include functionality to transmit and receive data, and transmit compressed gas to a pneumatic-based hydrostatic pressure compensation system of the marine vibrator 100.

It is to be appreciated that at least some of the functionality of the umbilical 130 can be separated across multiple umbilicals. For example, a first umbilical may be used to tow the marine vibrator 100 and one or more other umbilicals can be used for the other functionalities (e.g., to provide AC power, to transmit and receive data, and/or to transmit compressed gas).

The electromagnetic transducer 104, in some embodiments, can implement moving armature electromagnetic transduction which causes the radiating pistons to oscillate. By way of example, magnetic flux from permanent magnets located within the transducer couple to, and magnetically bias, the specially-shaped armature assembly. Currents carried via electrical coils produce an additional magnetic field, which is also coupled to the armature assembly. The sum of the magnetic fluxes creates a net force proportional to the drive current which is transferred from the armatures to the pistons via linear shafts. The resulting out-of-phase piston oscillation causes radiated sound in accordance with well-understood, classical, underwater acoustics in the low frequency regime. Unlike moving coil electrodynamic transducers that use Lorentz forcing, the moving armature electromagnetic transducer uses magnetic forcing and stationary coils providing a high degree of system reliability. Armature shaping, the control system, and other design features are used to reduce harmonic signal content. In addition, although the pistons can each produce 17,800 N (4000 lbs.) of peak dynamic force, they move in controlled opposition to one another in at least some embodiments such that the stator and integrated node experience negligible vibration. This provides a stable platform for towing and further enhances system reliability. The electromagnetic transducer 104 can produce arbitrary pressure waveforms including, but not limited to, up-swept or down-swept linear chirps, logarithmic chirps, phase or frequency shift keyed encoded waveforms, and pseudorandom noise.

The control-monitoring electronics system 102 performs several functions, including: monitoring engineering sensors and/or quality assurance sensors associated with the marine vibrator 100; housing biasing, signal conditioning, and analog to digital conversion electronics; hosting a digital controller (e.g., a field programmable gate array (FPGA) controller) with network connectivity (e.g., Ethernet connectivity); and hosting the pneumatic-based hydrostatic pressure compensation system. The engineering and quality assurance sensors can comprise low noise, high dynamic range accelerometers mounted on pistons associated with the electromagnetic transducer 104, for example. The readings from such sensors can be used to estimate an acoustic pressure radiated from the electromagnetic transducer 104. The control-monitoring electronics system 102 can regulate piston acceleration to ensure that the marine vibrator 100 produces an output pressure specified by a pilot or reference waveform, for example. The control-monitoring electronics system 102, in some embodiments, also ensures that the resulting pressure has a high signal to noise ratio and low harmonic distortion. It should be appreciated that the control-monitoring electronics system can include functionality that controls and/or monitors the marine vibrator 100.

In some embodiments, the pneumatic-based hydrostatic pressure compensation system can be at least partially integrated within a housing of the control-monitoring electronics system 102. For example, the compensating gas storage volume, plumbing, valve(s), compressor(s), and/or sensor(s) can be located within the same housing as the control-monitoring electronics system 102. Such embodiments can reduce the number of enclosures of the marine vibrator 100 and the corresponding number of seals (e.g., O-ring seals) that could leak, and can also reduce the mass and volume of the deployed marine vibrator 100.

Other features that can optionally reside at least partially within the marine vibrator 100 include one or more storage tanks (and associated piping and a valve network) containing high-pressure gas such as dry air or dry nitrogen to compensate the pistons as a result of submergence in water, and one or more batteries to provide a temporary source of electrical power to the control-monitoring system during deployment and retrieval operations when power from the survey vessel 110 may not available.

The control-monitoring electronics system 102 can host a pneumatic-based hydrostatic pressure compensation system. In such embodiments, the pressure compensation system can use a network of valves and dry compressed air supplied from the survey vessel or stored in a local storage tank (e.g., via the umbilical 130) to regulate the internal gas pressure of the electromagnetic transducer 104. By matching the internal gas pressure to the external hydrostatic pressure, the system can minimize the net hydrostatic forces on the pistons. These hydrostatic forces would otherwise cause the pistons to displace with changes in depth, gas temperature, or wave action, thereby reducing the dynamic range of the electromagnetic transducer 104. The compressed gas can be used to replenish the gas supplied by the storage tank(s) upon initial deployment. The gas in the storage tank is used to compensate for the piston resulting from the hydrostatic loads associated with submergence in water. A local source of compressed gas is preferred in at least some embodiments considering the latency issues of providing the gas directly from the survey vessel located up to 1 km away.

In the FIG. 1 example, the power amplifier 120 is located on the survey vessel 110. As noted above, this type of arrangement typically was unworkable with conventional arrangements, for example, due to constraints with amplifier technology. One or more aspects of the present disclosure recognize that recent advances allow gradient amplifiers to operate at 2,100 Vpk (or higher) and currents of 500 Apk (or higher). The marine vibrator 100 has a relatively fixed power requirement, and the increased voltage capability can be leveraged so that the power amplifier 120 can be separated from the marine vibrator 100. More specifically, the required wire gauge and diameter of the umbilical 130 to accommodate the reduced transducer current resulting from the increased voltage capability is sufficiently small. The diameter of the umbilical 130 that would be needed for conventional amplifiers (generally limited to maximum voltages of approximately 1400 V) would be unmanageable if separated from the transducer by more than two meters, for example. The higher operating voltages of the power amplifier 120 reduces the resulting current that is needed for the electromagnetic transducer 104, thereby reducing the voltage drop and required interconnect cable diameter.

Accordingly, the operating requirements of the power amplifier 120 depends in part on the length and diameter of the umbilical 130. As a non-limiting example, if the diameter of the umbilical 130 is three inches (which is compatible with many winches, blocks, pullies, and tuggers, for example) and the length of the umbilical 130 is 250 meters, then it would be sufficient for the power amplifier 120 to operate at 2,100 Vpk. However, it is to be appreciated that the voltage capability of the power amplifier 120 could be different in other embodiments depending on the diameter and length of the umbilical 130 required.

In some embodiments, more turns of wire (e.g., a copper wire) are added to the stationary drive coils of the electromagnetic transducer 104 (as compared to conventional marine vibrators) and the dielectric strength of the insulation material is increased to enable the electromagnetic transducer 104 to operate at higher voltages. Relative to co-located amplifiers, the power amplifier 120, in some embodiments, may include one or more of: higher voltage insulated-gate bipolar transistor (IGBT) module(s); multi-level switching configurations of IGBT module(s); and higher voltage rating silicon carbide field-effect transistor (SICFET) devices, switches, and/or modules. In some embodiments, the power amplifier 120 can be adapted from those used by the medical Magnetic Resonance Imaging industry, for example.

More specifically, assuming the magnetic circuit reluctance does not change, then the number of turns added to the stationary coils of the electromagnetic transducer 104 can increase by the square root of the ratio of the voltages. For example, if the drive voltage increases from 1400 V to 2100 V, then the number of turns would increase by a factor of the square root of 2100/1400, which would increase the number of turns by approximately 22%. This is because the inductance increases with the number of turns squared, the impedance increases linearly with inductance, and the voltage drop increases linearly with the impedance. Accordingly, the voltage drop increases with the square of the number of turns. The cross-sectional area of the wire used to create the coil with the desired number of turns decreases linearly with the ratio of the currents. The ratio of the currents is equal to the reciprocal of the ratio of the voltages (which in the example above is 1400/2100=0.66 times the original current). The radius of the wire can decrease with the square of the cross-sectional area. Accordingly, in some embodiments, the total mass of the wire can stay the same. However, it is to be appreciated that the number of turns can be increased and/or the diameter of the wire can be increased to improve the efficiency of the electromagnetic transducer 104.

As noted above, in some embodiments the dielectric strength can be increased to enable the electromagnetic transducer 104 to operate at higher voltages. For example, the dielectric strength can be increased by either adding more material, using a material with a higher dielectric constant, and/or by using an encapsulant having a higher dielectric strength constant. For example, in some embodiments, an additional, new layer of insulation is added, which can be enamel impregnated fiberglass, aromatic polyamide, mylar, or Dacron, as non-limiting examples.

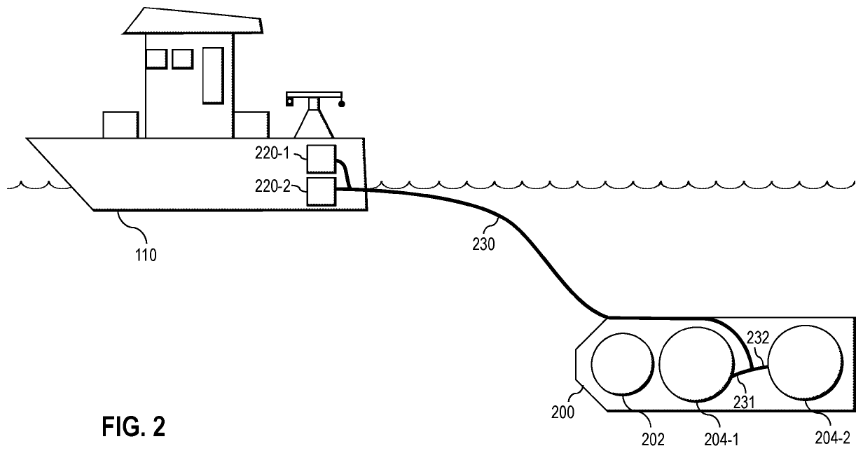

FIG. 2 is an elevation drawing showing a second deployment arrangement comprising a remotely amplified marine vibrator 200 in an illustrative embodiment. Generally, the marine vibrator 200 can be implemented similarly to the marine vibrator 100 in FIG. 1, except marine vibrator 200 is assumed to have multiple electromagnetic transducers. More specifically, the marine vibrator 200 in the FIG. 2 example includes electromagnetic transducers 204-1 and 204-2 (collectively electromagnetic transducers 204). Accordingly, it is assumed that the marine vibrator 200 includes a control-monitoring electronics system 202 and is towed by a survey vessel 110 via an umbilical 230, which can be implemented in a similar manner as umbilical 130. For example, the umbilical 230 can be connected to each of the electromagnetic transducers 204 and include functionality to provide AC drive signals from one or more power amplifiers 220-1 and 220-2 (collectively power amplifiers 220), located on the survey vessel 110, that are used to drive the electromagnetic transducers 204.

For example, in the FIG. 2 embodiment, the umbilical 230 splits into two smaller umbilicals 231 and 232, which respectively connect to the electromagnetic transducers 204-1 and 204-2. In other embodiments, each of the electromagnetic transducers 204 can be connected using a different umbilical 230. In yet another embodiment, the umbilical 230 can be connected to the electromagnetic transducer 204-1, and then another umbilical can be used to connect the electromagnetic transducer 204-1 to the electromagnetic transducer 204-2 (e.g., to provide the AC drive signals from the power amplifiers 220 and/or to transmit and receive data). Thus, it is to be appreciated that the umbilical 230 can be connected to the electromagnetic transducers 204 in a number of ways. It is also to be appreciated that, in at least some embodiments, the marine vibrator 200 may include more than two electromagnetic transducers and/or more than two power amplifiers. In one embodiment, each of the electromagnetic transducers 204 can have at least one corresponding power amplifier 220, for example.

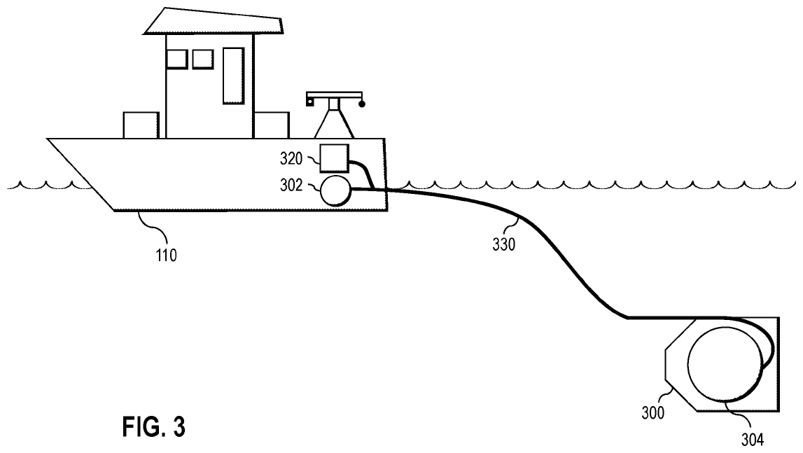

FIG. 3 is an elevation drawing showing a third deployment arrangement of a marine vibrator 300 having a power amplifier 320 and a control-monitoring electronics system 302 in an illustrative embodiment. Generally, the marine vibrator 300 comprises an electromagnetic transducer 304, which can be implemented similarly as described in conjunction with the marine vibrator 100 in FIG. 1. The marine vibrator 300 is connected to the power amplifier 320 and the control-monitoring electronics system 302 via at least one umbilical 330 (e.g., to provide the AC drive signals from the power amplifier 320 and/or to communicate data). Thus, it is to be appreciated that the umbilical 330 can be connected to the electromagnetic transducer 304 in a number of ways. It is also to be appreciated that, in at least some embodiments, the marine vibrator 300 may include two or more electromagnetic transducers with two or more power amplifiers and/or two or more control-monitoring electronics systems.

In some embodiments, at least some of the functionality associated with a control-monitoring electronics system (e.g., control-monitoring electronics system 102, 202, and/or 302) can be distributed across multiple components and/or at least partially integrated into one or more other components of the marine vibrators 100, 200, and/or 300, such as the electromagnetic transducer 104 and/or 204.

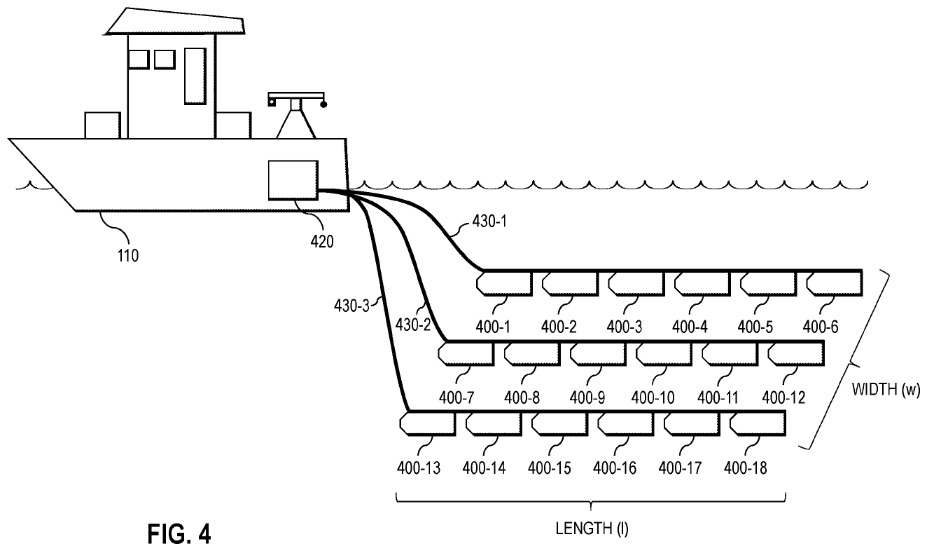

According to at least some embodiments, multiple marine vibrators (e.g., one or more marine vibrators 100, one or more marine vibrators 200, and/or one or more marine vibrators 300) can optionally be arranged to form a line array, which is towed by a survey vessel via an umbilical. Multiple line arrays of this type can be configured as a planar or volumetric array, as described in more detail in conjunction with FIG. 4, for example.

FIG. 4 is an elevation drawing showing a fourth deployment arrangement comprising an array of remotely amplified marine vibrators in an illustrative embodiment.

In the FIG. 4 example, the array includes three line arrays, each having six marine vibrators (labeled 400-1, . . . , 400-18, collectively referred to as marine vibrators 400). A given one of the marine vibrators 400 can be implemented in a similar manner as the marine vibrator 100, marine vibrator 200, and/or marine vibrator 300, for example. The width, w, and length, l, of the line array, in some embodiments, can each be approximately 18 meters. In practice, the number of elements in each array and how many arrays are deployed can be dictated by the seismic survey requirements, as would be apparent to a person of ordinary skill in the art based on the present disclosure. Additionally, the marine vibrators 400 in each of the line arrays are towed and connected by respective umbilicals 430-1, 430-2, and 430-3 (collectively referred to as umbilicals 430) beneath the water surface. The umbilicals 430 can each comprise a flexible, load-bearing structure that is connected to the survey vessel 110, in a similar manner as described above with respect to FIG. 1, for example. The umbilicals 430 are also connected to a plurality of power amplifiers 420 located on the survey vessel 110. In some embodiments, each of the marine vibrators 400 is provided AC power by a corresponding one of the plurality of power amplifiers 420.

It is to be appreciated that in other embodiments, there may be a different number of power amplifiers 420 than the number of marine vibrators. For example, the power amplifiers 420 can correspond to an amplifier system that comprises a set of two transconductance current sources powered by a common power supply. Different coil sets (e.g., a port coil set and starboard coil set) can be energized by independent channels (or “axis”) so that their acceleration can be independently controlled. In such an example, multiple sets of transconductance current sources can be powered off a common power supply. As a non-limiting example, a large power supply can be provided that can power 12 axes. Accordingly, it is to be appreciated that one of the power amplifiers 420 can provide power to multiple marine vibrators 400 if they are not energized simultaneously.

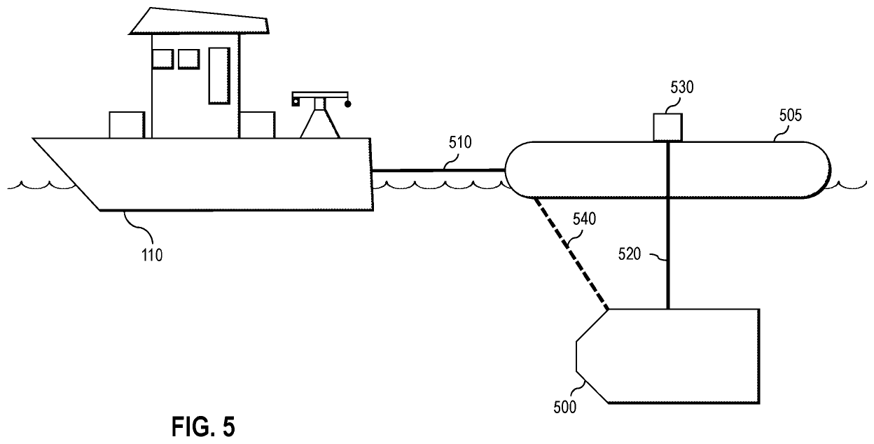

FIG. 5 is an elevation drawing showing a fourth deployment arrangement comprising a remotely amplified marine vibrator 500 suspended from a float 505 (e.g., a barge) in an illustrative embodiment. As shown in FIG. 5, the float 505 is towed behind the survey vessel 110 using a tow line 510, and the marine vibrator 500 is suspended from the float 505 by an umbilical 520. The marine vibrator 500 can be implemented in a similar manner as the marine vibrator 100, the marine vibrator 200, and/or the marine vibrator 300, for example. The umbilical 520 provides power from a power amplifier 530 located on (or at least partially within) the float 505. In embodiments where the marine vibrator 500 is implemented as marine vibrator 300, at least some of the components of the control-monitoring electronics system 302 may be located on or at least partially within the float 505.

The umbilical 520 can comprise a load-bearing structure connected to the marine vibrator 500 such that the marine vibrator remains suspended from the float 505 while it is being towed from the float 505. Optionally, rigging 540 (e.g., one or more cables and/or one or more ropes) can be connected to the marine vibrator 500. This arrangement can help keep the leading edge of the marine vibrator 500 pointed in the direction the marine vibrator 500 is being towed. For example, the tow line 510 is often exposed to various forces (e.g., associated with drag in the water and/or boat movements), which can cause the frame of the marine vibrator 500 to twist. The rigging 540 uses the natural drag of the system to keep the heading in line with the tow direction. It is noted that the umbilical 520 can include functionality similar to the umbilicals 130, 230, and 330, for example.

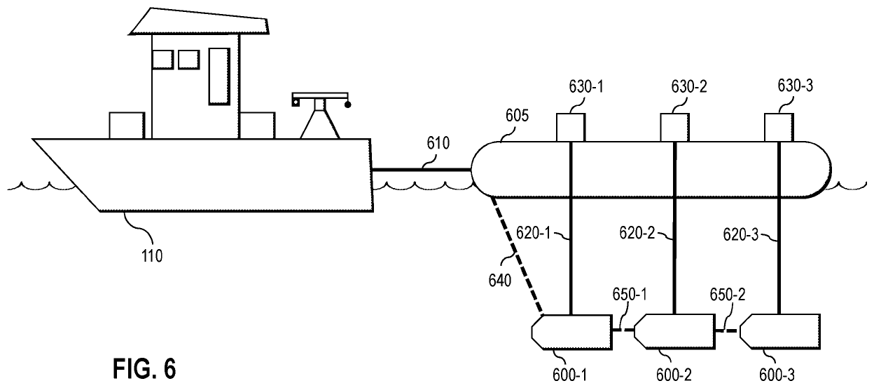

FIG. 6 is an elevation drawing showing a fifth deployment arrangement comprising multiple remotely amplified marine vibrators 600-1, 600-2, and 600-3 (collectively referred to as marine vibrators 600) suspended from a float 605 in an illustrative embodiment. A given one of the marine vibrators 600 can be implemented in a similar manner as the marine vibrator 100, the marine vibrator 200, or the marine vibrator 300, for example.

Similar to FIG. 5, the float 605 is towed behind the survey vessel 110 using a tow line 610. The marine vibrators 600 are suspended from the float 605 by respective umbilicals 620-1, 620-2, and 620-3 (collectively referred to as umbilicals 620). In this embodiment, the umbilicals 620-1, 620-2, and 620-3 are connected to power amplifiers 630-1, 630-2, and 630-3, respectively, located on (or at least partially within) the float 605. The umbilicals 620 can each be implemented in a similar manner as the umbilical 520 of FIG. 5, for example. In the FIG. 6 example, rigging 640 (e.g., one or more cables and/or one or more ropes) is optionally connected to the marine vibrator 600-1 while it is suspended from the float 605. This arrangement can help keep the leading edge of the marine vibrator 600-1 pointed in the direction it is being towed, as noted above in conjunction with FIG. 5. In at least some embodiments, the marine vibrators 600 (or at least a portion of the marine vibrators) can also optionally be connected using lines 650-1 and 650-2, to form a “train.” Such embodiments can keep drag-induced tension in line with tow direction, for example.

In other embodiments, one or more other marine vibrators 600 can also be rigged to the float 605 with additional cables and/or ropes. In practice, the number of elements suspended from the float 605 can be dictated by the seismic survey requirements, for example.

FIGS. 1-6 are merely examples of marine vibrator arrangements, and it is to be appreciated that other arrangements are also possible. For example, a given power amplifier can be located on a self-contained shipping container separate from a corresponding marine vibrator (or multiple marine vibrators). As another example, a given power amplifier can be located onboard an oil and gas platform and can provide power to a corresponding marine vibrator 100, 200, and/or 300 suspended or rigged from the oil and gas platform via an umbilical (in a similar manner as described in conjunction with FIGS. 1-6). Such an embodiment can be useful for vertical seismic profile (VSP) testing, for example.

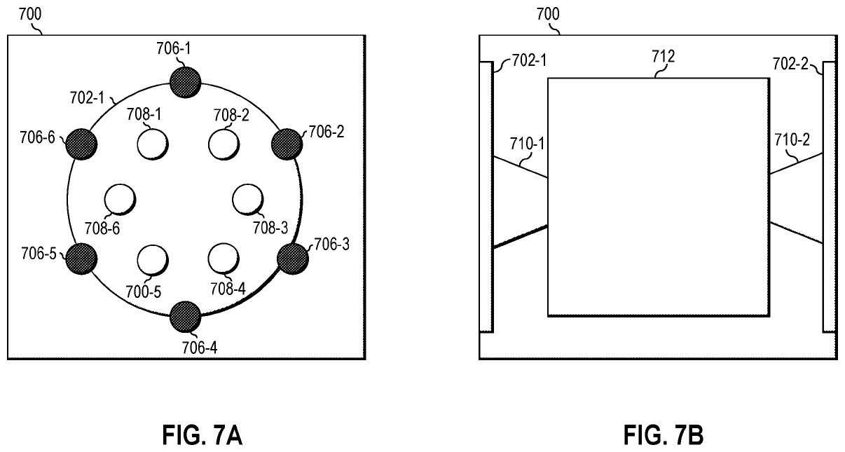

FIG. 7A and FIG. 7B (collectively referred to as FIG. 7) show front and side views, respectively, of a marine vibrator 700 having two sets of sensors in accordance with illustrative embodiments. The sensor arrangement depicted in FIG. 7 can be implemented in marine vibrators 100, 200, and/or 300, for example.

It is noted that the marine vibrator 700 in the FIG. 7 example is implemented using a back-to-back (e.g., symmetrical) arrangement of piston assemblies, however, those skilled in the art will appreciate that other arrangements are also possible. Generally, a given marine vibrator can comprise one or more piston assemblies.

In the example shown in FIG. 7, the marine vibrator 700 includes two pistons 702-1 and 702-2 (collectively pistons 702), and a moving armature assembly 712. The moving armature assembly 712 can produce a force (e.g., via permanent magnets and electrical coils), which is transmitted from the moving armature assembly 712 to the respective pistons 702 via drive linkages 710-1 and 710-2.

FIG. 7A also shows a first set of sensors 706-1, . . . , 706-6 that measure an acceleration of the pistons 702-1, and a second set of sensors 708-1, . . . , 708-6 that measure an acceleration of a stator associated with the moving armature assembly 712. It is noted that the other side of the marine vibrator 700 comprising piston 702-2 can have a similar sensor arrangement as shown in FIG. 7A. In this embodiment, it is assumed that the first set of sensors 706 are spaced sixty degrees apart, and the second set of sensors 708 are also spaced sixty degrees apart. It is noted that other sensor arrangements are also possible. For example, in some embodiments, a single sensor may be located at the center of the piston and a single sensor may be colinearly located at the center of the stator, such that the sensors can be used to measure the accelerations due to pitch, yaw, and roll of the marine vibrator as it is towed through the water. However, in some marine vibrators a shaft linking the piston to the armature can be positioned at that location, thereby resulting in a radial offset from the center of any sensors. In such situations, at least three sensors in each of the first set and second set of sensors can be used to measure the planar acceleration.

When the sensors are arranged such that they have equal angles between each other and are equidistant from a center point (as is the case in FIG. 7) then there can be an equal weighting of the amplitude in the geometric mean. It is to be appreciated that other arrangements are also possible if the amplitude is weighted as a function of angle and radius.

According to some embodiments, a relative acceleration in a direction normal to the face of the piston 702-1 is calculated based on the difference between the geometric mean of the first set of sensors and the geometric mean of the second set of sensors. This acceleration (which can be referred to as the “net acceleration”) can be controlled by adjusting the transducer drive current in substantially real time. In this context, “substantially” refers to the delay that can occur, for example, due to collecting and/or processing the measurements from the sensors, for example.

In an alternative embodiment, the associated sensors that measure the acceleration of a stator associated are optional, and the net acceleration is the sum of the acceleration of each of the pistons (e.g., 710-1 and 710-2). The net acceleration can then be controlled by adjusting the current that drives the respective pistons. Such an embodiment would accomplish similar results without having to measure the acceleration relative to the stator.

In one exemplary embodiment, a marine vibrator includes at least one electromagnetic transducer, a control-monitoring electronics system, and a frame, where the at least one electromagnetic transducer is at least partially within the frame. The at least one electromagnetic transducer receives AC electrical power from one or more power amplifiers, via at least one umbilical that connects the at least one electromagnetic transducer and the one or more power amplifiers, where the one or more power amplifiers are remotely located from the marine vibrator.

The marine vibrator may be configured to be towed by a survey vessel such that at least one of the one or more power amplifiers and at least a portion of the control-monitoring electronics system may be located on the survey vessel when the marine vibrator is being towed. A plurality of the marine vibrators may be arranged in a line array and towed at least partially beneath a water surface. The one or more power amplifiers may include a plurality of power amplifiers, and a given one of the marine vibrators in the line array may receive AC electrical power from a respective one of the plurality of power amplifiers. The frame may be a free-flooding, load-bearing frame, and the frame may be suspended from a surface float by one or more cable assemblies. The surface float may be towed by the survey vessel via a cable that connects the surface float to the survey vessel. The one or more power amplifiers and/or at least a portion of the control-monitoring electronics system may be located on or at least partially within the surface float. In some embodiments, a plurality of the marine vibrators may be suspended from the surface float, and the one or more power amplifiers may include a plurality of power amplifiers located on or at least partially within the surface float. A given one of the plurality of marine vibrators may receive AC electrical power from a respective one of the plurality of power amplifiers located on the surface float. The at least one umbilical may include a load-bearing, flexible umbilical comprising functionality to transmit the AC electrical power and one or more of: data and compressed gas to the marine vibrator. The control-monitoring electronics system may regulate piston acceleration of the at least one electromagnetic transducer to satisfy a specified output pressure, and the control-monitoring electronics system may further include a pressure compensation system to regulate an internal gas pressure of the at least one electromagnetic transducer. The one or more power amplifiers may include an integrated cooling system (e.g., a forced water-cooling system) that enables the marine vibrator to operate at full power operation without being fully submerged. The marine vibrator may include two or more electromagnetic transducers, where the two or more electromagnetic transducers receive the AC electrical power from the one or more power amplifiers, via the same at least one umbilical.

In another illustrative embodiment, a marine vibrator includes at least one electromagnetic transducer, where the at least one electromagnetic transducer receives AC electrical power from one or more power amplifiers that are remotely located from the at least one marine vibrator, via at least one umbilical that connects the electromagnetic transducer and at least one of the one or more power amplifiers.

In yet another illustrative embodiment, a marine vibrator system may include one or more power amplifiers, a control-monitoring electronics system, and at least one marine vibrator. The at least one marine vibrator includes at least one electromagnetic transducer and a frame, where the at least one electromagnetic transducer is at least partially within the frame. At least one of the one or more power amplifiers and at least a portion of the control-monitoring electronics system are remotely located from the at least one marine vibrator. The one or more power amplifiers transmit AC electrical power to the at least one electromagnetic transducer, via at least one umbilical that connects the at least one electromagnetic transducer to at least one of the one or more power amplifiers.

The at least one marine vibrator may be towed by a survey vessel, and the one or more power amplifiers may be located on the survey vessel while the marine vibrator is being towed. The at least one marine vibrator may be suspended from an oil and gas platform at least partially beneath a water surface via the at least one umbilical, and the one or more power amplifiers may be located on the oil and gas platform. The at least one marine vibrator may include a plurality of the marine vibrators arranged in a line array and towed at least partially beneath a water surface. The one or more power amplifiers may include a plurality of power amplifiers, and a given one of the marine vibrators in the line array may receive AC electrical power from a respective one of the plurality of power amplifiers. The frame may be a free-flooding, load-bearing frame, and the marine vibrator system may further include: a surface float that suspends the free-flooding, load-bearing frame by one or more load-bearing cable assemblies, where the surface float is towed by a survey vessel via a cable that connects the surface float to the survey vessel. The one or more power amplifiers and/or at least a portion of the control-monitoring electronics system may be located on or at least partially within the surface float. The at least one umbilical may include a load-bearing, flexible umbilical comprising functionality to transmit the AC electrical power and one or more of: data and compressed gas to the marine vibrator. The control-monitoring electronics system may regulate piston acceleration of the at least one electromagnetic transducer to satisfy a specified output pressure, and the control-monitoring electronics system may further include a pressure compensation system to regulate an internal gas pressure of the at least one electromagnetic transducer.

Another illustrative embodiment includes a marine vibrator, comprising at least one electromagnetic transducer. The at least one electromagnetic transducer includes at least one piston, at least one moving armature assembly that drives the at least one piston based on alternating current (AC) electrical power received from one or more power amplifiers associated with the marine vibrator, a first set of sensors that measures an acceleration of the at least one piston, and a second set of sensors that measures an acceleration of a stator of the at least one moving armature assembly. The acceleration of the at least one piston relative to the acceleration of the stator is controlled, in substantially real time, by adjusting the AC electrical power based at least in part on the accelerations measured by the first set of sensors and the second set of sensors.

The one or more power amplifiers may be remotely located from the marine vibrator. The at least one electromagnetic transducer may receive the AC electrical power from the one or more power amplifiers via at least one umbilical that connects the at least one electromagnetic transducer and the one or more power amplifiers.

The marine vibrator arrangements described herein provide a number of advantages relative to conventional marine vibrators, such as decreasing overall cost, improving access for maintenance and troubleshooting, and/or reducing the weight and size of the deployed marine vibrator. For example, a conventional marine vibrator can weigh approximately 7,500 pounds, whereas a remotely amplified marine vibrator in accordance with some embodiments can weigh substantially less (e.g., approximately 4000 pounds) making it substantially easier to deploy and handle. Additionally, a remotely located power amplifier (relative to the one or more marine vibrators) does not need to be ruggedized or marinized for deployment off a ship and for submerged operation. The remotely located power amplifiers can be part of a rack-mount amplifier system, which includes integrated forced water cooling. This enables full power operation without having to fully submerge the marine vibrator, which can be particularly useful for testing and integration purposes, for example.

One or more embodiments of the disclosure provide methods to package and deploy marine vibrators having one or more remote components (e.g., one or more remote amplifiers and/or one or more remote control-monitoring electronics system) for use in connection with marine seismic surveys. The foregoing applications and associated embodiments should be considered as illustrative only, and numerous other embodiments can be configured using the techniques disclosed herein, in a wide variety of different marine seismic applications.

It should also be understood that the marine vibrator configurations, as described herein, can be implemented at least in part in the form of one or more software programs stored in memory and executed by a processor of a processing device such as a computer. A memory or other storage device having such program code embodied therein is an example of what is more generally referred to herein as a “computer program product.”

The disclosed marine vibrator configurations may be implemented, at least in part, using one or more processing platforms. One or more of the processing modules or other components may therefore each run on a computer, storage device, or other processing platform element. A given such element may be viewed as an example of what is more generally referred to as a “processing device.”

Without in any way limiting the scope, interpretation, or application of the claims appearing below, technical effects of one or more of the example embodiments disclosed herein include, for example, decreasing the mass of marine vibrator deployments, improved onboard handling and deployed handling of marine vibrators, decreased volume of marine vibrator deployments, and/or improved towing dynamics.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A marine vibrator, comprising:
at least one electromagnetic transducer;
a control-monitoring electronics system; and
a frame, wherein the at least one electromagnetic transducer is at least partially within the frame;
wherein the at least one electromagnetic transducer receives alternating current (AC) electrical power from one or more power amplifiers, via at least one umbilical that connects the at least one electromagnetic transducer and the one or more power amplifiers, wherein the one or more power amplifiers are remotely located from the marine vibrator.

2. The marine vibrator of claim 1, wherein the marine vibrator is towed at least partially beneath a water surface by a survey vessel and at least one of: the one or more power amplifiers and at least a portion of the control-monitoring electronics system are located on the survey vessel.

3. The marine vibrator of claim 1, wherein:
a plurality of the marine vibrators is arranged in a line array and towed at least partially beneath a water surface by a survey vessel; and
the one or more power amplifiers comprise a plurality of power amplifiers, and wherein a given one of the marine vibrators in the line array receives AC electrical power from a respective one of the plurality of power amplifiers.

4. The marine vibrator of claim 1, wherein the frame is a free-flooding, load-bearing frame and is suspended from a surface float by one or more cable assemblies, and wherein the surface float is towed by a survey vessel via a cable that connects the surface float to the survey vessel.

5. The marine vibrator of claim 4, wherein at least one of: the one or more power amplifiers and at least a portion of the control-monitoring electronics system is located on or at least partially within the surface float.

6. The marine vibrator of claim 4, wherein:
a plurality of the marine vibrators is suspended from the surface float;
the one or more power amplifiers comprise a plurality of power amplifiers located on or at least partially within the surface float; and
a given one of the plurality of marine vibrators receives AC electrical power from a respective one of the plurality of power amplifiers located on the surface float.

7. The marine vibrator of claim 1, wherein the at least one umbilical comprises a load-bearing, flexible umbilical comprising functionality to transmit the AC electrical power and one or more of data and compressed gas to the marine vibrator.

8. The marine vibrator of claim 1, wherein the control-monitoring electronics system regulates piston acceleration of the at least one electromagnetic transducer to satisfy a specified output pressure, and wherein the control-monitoring electronics system further comprises a pressure compensation system to regulate an internal gas pressure of the at least one electromagnetic transducer.

9. The marine vibrator of claim 1, wherein the one or more power amplifiers comprise an integrated cooling system that enables the marine vibrator to operate at full power operation without being fully submerged.

10. The marine vibrator of claim 1, comprising two or more electromagnetic transducers, wherein the two or more electromagnetic transducers receive the AC electrical power from the one or more power amplifiers, via the same at least one umbilical.

11. A marine vibrator system, comprising:
one or more power amplifiers;
a control-monitoring electronics system; and
at least one marine vibrator comprising:
at least one electromagnetic transducer; and
a frame, wherein the at least one electromagnetic transducer is at least partially within the frame;
wherein at least one of the one or more power amplifiers and at least a portion of the control-monitoring electronics system are remotely located from the at least one marine vibrator, and wherein the one or more power amplifiers transmit alternating current (AC) electrical power to the at least one electromagnetic transducer, via at least one umbilical that connects the at least one electromagnetic transducer to at least one of the one or more power amplifiers.

12. The marine vibrator system of claim 11, wherein the at least one marine vibrator is towed by a survey vessel at least partially beneath a water surface, and wherein the one or more power amplifiers are located on the survey vessel.

13. The marine vibrator system of claim 11, wherein the at least one marine vibrator is suspended from an oil and gas platform at least partially beneath a water surface via the at least one umbilical, and wherein the one or more power amplifiers are located on the oil and gas platform.

14. The marine vibrator system of claim 11, comprising a plurality of the marine vibrators arranged in a line array and towed at least partially beneath a water surface, wherein the one or more power amplifiers comprise a plurality of power amplifiers, and wherein a given one of the marine vibrators in the line array receives AC electrical power from a respective one of the plurality of power amplifiers.

15. The marine vibrator system of claim 11, wherein the frame is a free-flooding, load-bearing frame, and wherein the marine vibrator system further comprises:
a surface float that suspends the free-flooding, load-bearing frame by one or more load-bearing cable assemblies, wherein the surface float is towed by a survey vessel via a cable that connects the surface float to the survey vessel.

16. The marine vibrator system of claim 15, wherein at least one of: the one or more power amplifiers and at least a portion of the control-monitoring electronics system is located on or at least partially within the surface float.

17. The marine vibrator system of claim 11, wherein the at least one umbilical comprises a load-bearing, flexible umbilical comprising functionality to transmit the AC electrical power and one or more of data and compressed gas to the marine vibrator.

18. The marine vibrator system of claim 11, wherein the control-monitoring electronics system regulates piston acceleration of the at least one electromagnetic transducer to satisfy a specified output pressure, and wherein the control-monitoring electronics system further comprises a pressure compensation system to regulate an internal gas pressure of the at least one electromagnetic transducer.

19. A marine vibrator, comprising:
at least one electromagnetic transducer comprising:
at least one piston;
at least one moving armature assembly that drives the at least one piston based on alternating current (AC) electrical power received from one or more power amplifiers associated with the marine vibrator;
a first set of sensors that measures an acceleration of the at least one piston, and
a second set of sensors that measures an acceleration of a stator of the at least one moving armature assembly;
wherein the acceleration of the at least one piston relative to the acceleration of the stator is controlled, in substantially real time, by adjusting the AC electrical power based at least in part on the accelerations measured by the first set of sensors and the second set of sensors.

20. The marine vibrator of claim 19, wherein the one or more power amplifiers are remotely located from the marine vibrator, and wherein the at least one electromagnetic transducer receives the AC electrical power from the one or more power amplifiers via at least one umbilical that connects the at least one electromagnetic transducer and the one or more power amplifiers.
